(19) United States
(12) Patent Application Publication
(10) Pub. No.: US 2009/0318184 A1
(43) Pub. Date: Dec. 24, 2009

(54) Terminal device and method

(75) Inventors: Toshihiro Azami, Kawasaki (JP); Hiroshi Kanno, Kawasaki (JP); Ikuro Hibino, Kawasaki (JP); Sosuke Jogo, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/320,994

(22) Filed: Feb. 10, 2009

(30) Foreign Application Priority Data
Jun. 19, 2008 (JP) 2008-160936

(51) Int. Cl. H04M 1/00

(52) U.S. Cl. 455/550.1

(57) ABSTRACT

A disclosed terminal device includes a detecting unit configured to detect whether the terminal device is held by a user; a judging unit configured to determine whether a predetermined condition is satisfied in the case where the terminal device is detected to be held; and an output unit configured to make a predetermined output in the case where the predetermined condition is determined to be satisfied.

### CROSS-REFERENCE TO RELATED APPLICATIONS

This application is based upon and claims the benefit of priority of Japanese Patent Application No. 2008-160936, filed on Jun. 19, 2008, the entire contents of which are hereby incorporated herein by reference.

### FIELD

The disclosure herein is directed to a terminal device and a method for executing a specific processing operation.

### BACKGROUND

With terminal devices, for example mobile terminals, the current time can be obtained by pressing a specific button or unfolding folding cases of the terminal devices.

In the case when the user wants to know the time in the dark while in bed, for example, the current time can be displayed on the display screen of a mobile terminal by pressing a manual operation button on the mobile terminal. If a mobile terminal is foldable, the current time is displayed on the display screen of the mobile terminal by unfolding the folding mobile terminal.
[Non-patent Document 1] [Online] [Retrieved on Apr. 30, 2008] Internet <URL: www.nttdocomo.co.jp/binary/pdf/support/trouble/manual/download/904i/f904i/F904i_J_{—}02.pdf>, p. 31-32

It is, however, difficult to find in the dark the manual operation button that needs to be pressed. In addition, it is sometimes the case that the display of the main screen of the mobile terminal is too bright for eyes accustomed to darkness.

### SUMMARY

In order to solve at least one of the above-described problems, the terminal device of the present disclosure includes a detecting unit configured to detect whether the terminal device is held by a user; a judging unit configured to determine whether a predetermined condition is satisfied in the case where the terminal device is detected to be held; and an output unit configured to make a predetermined output in the case where the predetermined condition is determined to be satisfied.

According to another aspect of the present disclosure, a method used on a terminal device includes detecting whether the terminal device is held by a user; determining whether a predetermined condition is satisfied in the case where the terminal device is detected to be held; and making a predetermined output in the case where the predetermined condition is determined to be satisfied.

The object and advantages of the disclosure will be realized and attained by means of the elements and combinations particularly pointed out in the claims.

It is to be understood that both the foregoing general description and the following detailed description are exemplary and explanatory and are not restrictive of the present disclosure as claimed.

### BRIEF DESCRIPTION OF DRAWINGS

FIG. 1 is a partial block diagram of a terminal device according to one embodiment;

FIG. 2 is a partial block diagram of a terminal device according to one embodiment;

FIG. 3 is a flowchart showing operations of the terminal device according to the embodiment;

FIG. 4 is a partial block diagram of a terminal device according to another embodiment;

FIG. 5 is a flowchart showing operations of the terminal device according to the embodiment;

FIG. 6 is a partial block diagram of a terminal device according to yet another embodiment;

FIG. 7 is a flowchart showing operations of the terminal device according to the embodiment;

FIG. 8 is a partial block diagram of a terminal device according to yet another embodiment;

FIG. 9 is a flowchart showing operations of the terminal device according to the embodiment;

FIG. 10 is a partial block diagram of a terminal device according to yet another embodiment;

FIG. 11 is a flowchart showing operations of the terminal device according to the embodiment;

FIG. 12 is a partial block diagram of a terminal device according to yet another embodiment; and

FIG. 13 is a flowchart showing operations of the terminal device according to the embodiment.

### DESCRIPTION OF EMBODIMENT

Embodiments that describe the best mode for carrying out the present disclosure are explained next with reference to the drawings.

In all of the drawings for illustrating the embodiments, components having the same function are identified by the same reference numerals, and repeated explanations will be omitted.

Next is described a terminal device 100 according to the embodiments of the present disclosure. Examples of the terminal device 100 of the embodiments of the present disclosure are mobile terminals and personal digital assistants (PDA).

The terminal device 100 includes a detecting unit for detecting whether the terminal device 100 is held. The detecting unit detects some kind of contact made on the terminal device 100. For example, the detecting unit may be designed to detect that the user has grabbed the terminal device 100. In addition, the detecting unit may be designed to detect not only a direct grasp of the terminal device 100 but also (physical) contact directly and/or indirectly made with the terminal device 100. For example, the detecting unit may be designed to detect a nudge and/or a tap made on the terminal device 100.

The terminal device 100 may include, as the detecting unit, at least one of an acceleration sensor, an angular velocity sensor (gyro-sensor), a force sensor and an electrostatic sensor, for example. Or the terminal device 100 may include a device other than the above-described sensors provided that the device is capable of detecting a physical contact. The following embodiments of the present disclosure are described through an example in which an acceleration sensor is used as the detecting unit. In this case, the terminal device 100 periodically reads an output of the acceleration sensor. If a change equal to or higher than a predetermined level is found in the read acceleration, the terminal device 100 determines that the user is holding the terminal device 100.

The terminal device 100 includes a judging unit for determining whether to execute a processing operation. If the detecting unit detects that the terminal device 100 is grasped by the user, the judging unit determines whether a predetermined condition is satisfied at this moment. The predetermined condition may be that the detecting unit did not detect a grasp on the terminal device 100 over a predetermined period of time prior to the current grasp. For example, in the case where the detecting unit detects that the terminal device 100 is grasped, the judging unit determines that the condition is satisfied if no grasp detection on the terminal device 100 has been made over a predetermined period of time, e.g. one hour or so, after the previous detection prior to the current detection.

The judging unit for determining whether to execute a processing operation may determine that the condition is satisfied if the terminal device 100 is in an operation mode other than an operation mode in which an audio output is not allowed. For example, when an incoming call arrives, the judging unit determines that the condition is satisfied if the terminal device 100 is not in silent mode where the terminal device 100 vibrates but does not ring.

The judging unit for determining whether to execute a processing operation may determine that the condition is satisfied if the current time falls within a predetermined time window. For example, the judging unit determines that the condition is satisfied if the current time falls within the time window between 0:00 and 6:00. The time window may be preset as a time period during which an audio output is allowed.

The terminal device 100 of the embodiments of the present disclosure includes an executing unit for executing a processing operation. In the case where the judging unit determines to execute a processing operation, the executing unit executes the processing operation. For example, in the case where the processing operation is an audio output of the time, the executing unit may include an audio synthesizing unit and a speaker for outputting synthesized sound.

The following embodiments of the present disclosure are described through examples in which the processing operation to be executed is an audio output and/or display of information, such as the current time, whether or not mail has been received, or weather forecast. For example, the terminal device 100 synthesizes audio and outputs the synthesized audio from the speaker. Alternatively, the terminal device 100 may present such information on the display. The display may be either a main display or a sub display. One embodiment of the present disclosure below describes a case in which information is presented on the sub display. Other than information on the current time, whether or not mail has been received, or weather forecast, a schedule or a news headline may be output in audio format and/or displayed.

### (a) First Embodiment

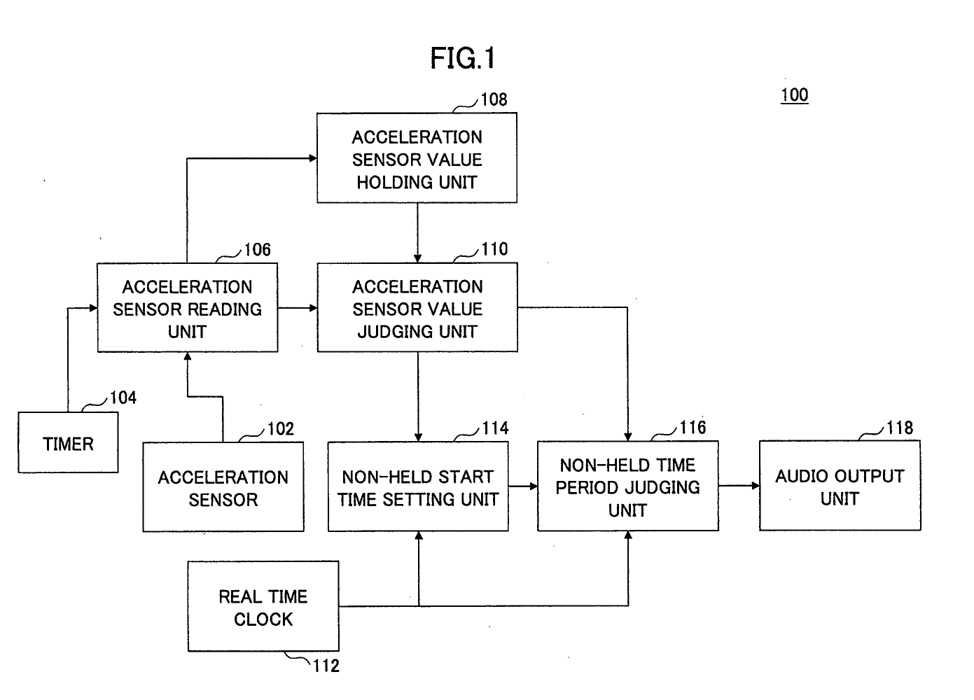

The terminal device 100 according to the first embodiment is explained next with reference to FIG. 1.

The terminal device 100 of the present embodiment outputs the current time in audio format.

The terminal device 100 of the present embodiment includes an acceleration sensor 102. The acceleration sensor 102 detects a contact action on the terminal device 100. For example, the acceleration sensor 102 detects some kind of contact made by the user on the terminal device 100. The acceleration sensor 102 detects, for example, the acceleration applied to the terminal device 100. The acceleration sensor 102 inputs the detected acceleration to an acceleration sensor reading unit 106 to be described below.

The terminal device 100 of the present embodiment includes a timer 104. The timer 104 inputs a timer value to the acceleration sensor reading unit 106.

The terminal device 100 of the present embodiment includes the acceleration sensor reading unit 106. The acceleration sensor reading unit 106 periodically reads the value of the acceleration sensor 102 based on the timer value input by the timer 104. The acceleration sensor reading unit 106 inputs the value of the acceleration sensor 102 to an acceleration sensor value holding unit 108 and an acceleration sensor value judging unit 110.

The terminal device 100 of the present embodiment includes the acceleration sensor value holding unit 108. The acceleration sensor value holding unit 108 holds the input value of the acceleration sensor 102. The acceleration sensor value holding unit 108 inputs the holding value of the acceleration sensor 102 to the acceleration sensor value judging unit 110.

The terminal device 100 of the present embodiment includes the acceleration sensor value judging unit 110. Based on the values of the acceleration sensor 102 input from the acceleration sensor reading unit 106 and from the acceleration sensor value holding unit 108, the acceleration sensor value judging unit 110 determines whether the terminal device 100 is grasped (held) by the user. The acceleration sensor value judging unit 110 may determine that the terminal device 100 is grasped by the user in the case when, for example, the acceleration input from the acceleration sensor reading unit 106 differs from the acceleration input from the acceleration sensor value holding unit 108. In this case, the sensor value input from the acceleration sensor value holding unit 108 has been obtained prior to the sensor value input from the acceleration sensor reading unit 106. The previously read sensor value is preferably an acceleration value obtained when the terminal device 100 is not held by the user.

Alternatively, the acceleration sensor value judging unit 110 may determine that the terminal device 100 is held by the user in the case when the sensor value input from the acceleration sensor reading unit 106 is equal to or greater than a predetermined threshold. The predetermined threshold may be the lowest value of the acceleration applied when the terminal device 100 is being grasped by the user.

In addition, the acceleration sensor value judging unit 110 may determine not only whether the terminal device 110 is held in the user's hand by grasping it, but also whether the terminal device 100 is nudged or tapped. In the case of determining that the terminal device 100 is held by the user, the acceleration sensor value judging unit 110 inputs to a non-held start time setting unit 114 and a non-held time period judging unit 116 to be described below information indicating that the terminal device 100 is being held.

The terminal device 100 of the present embodiment includes a real time clock 112. The real time clock 112 inputs a clock value to the non-held start time setting unit 114 and the non-held time period judging unit 116 to be described below. The clock value may indicate the current time.

The terminal device 100 of the present embodiment includes the non-held start time setting unit 114. In the case where the terminal device 100 is not held by the user, the non-held start time setting unit 114 sets the start time of the time period during which the terminal device 100 is not being held by the user (hereinafter, simply referred to as “start time”) based on the information input by the acceleration sensor value judging unit 110 and indicating that the terminal device 100 is being held and the clock value input from the real time clock 112. The non-held start time setting unit 114 inputs the start time to the non-held time period judging unit 116.

The terminal device 100 of the present embodiment includes the non-held time period judging unit 116. The non-held time period judging unit 116 obtains the elapsed time during which the terminal device 100 is not being held, based on the start time input from the non-held start time setting unit 114, the information input from the acceleration sensor value judging unit 110, and the clock value input from the real time clock 112. Then, if the obtained elapsed time is equal to or exceeds a predetermined period of time, the non-held time period judging unit 116 directs an audio output unit 118 to be described below to output the current time. The predetermined period of time may be set in advance.

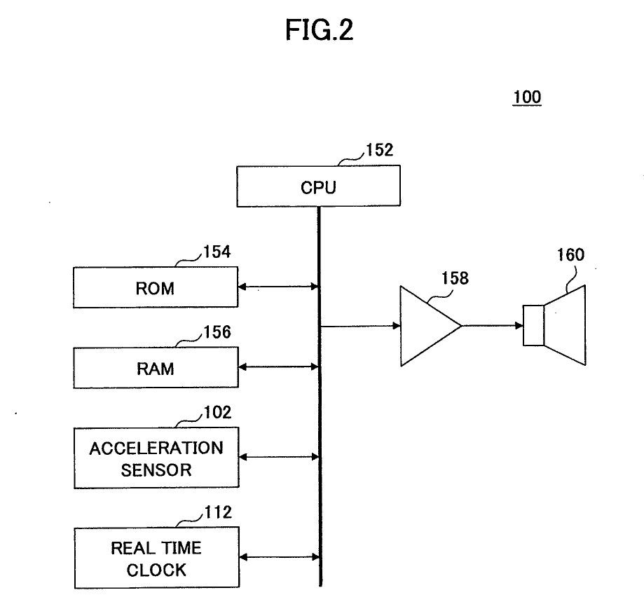

Next is described an example of a hardware structure of the terminal device 100 of the present embodiment with reference to FIG. 2.

The terminal device 100 of the present embodiment includes a CPU 152, a ROM 154, a RAM 156, an amplifier 158 and a speaker 160. In addition, the terminal device 100 includes the acceleration sensor 102 and the real time clock 112, as mentioned above.

A program causing the CPU 152 to function as the terminal device 100 is written to the ROM 154 in a production stage. The CPU 152 executes processes to be explained in the present embodiment according to the program. Alternatively, the program may be provided in the form of a recording medium, such as a flexible disk, a CD-ROM, or a memory card, on which the program is recorded. The recording medium may be inserted into a secondary storage device connected to the terminal device 100, whereby the program recorded on the recording medium is read, and then written to the ROM 154 and executed. In this case, the ROM 154 may be formed of a writable flash memory. Furthermore, the program may be downloaded via a communication network and written to the ROM 154 formed of a writable flash memory, and then executed. Or the program read from the recording medium or downloaded may be copied and installed in a hard disk device and then executed.

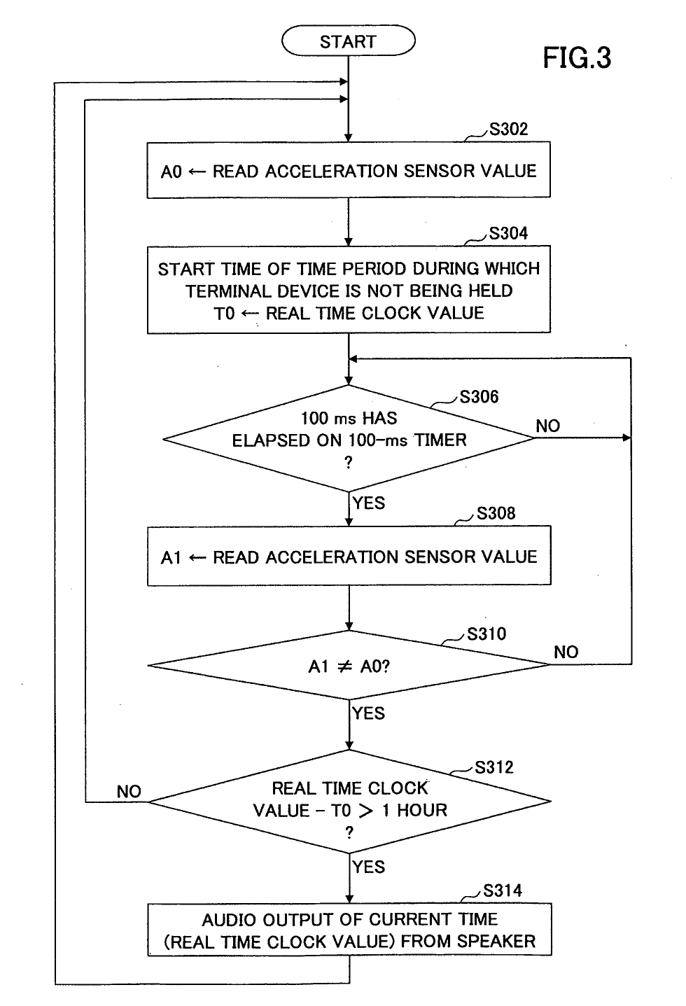

Operations of the terminal device 100 of the present embodiment are explained next with reference to FIG. 3.

The terminal device 100 reads the acceleration sensor value (Step S302). For example, the acceleration sensor reading unit 106 reads the sensor value input from the acceleration sensor 102. The acceleration sensor reading unit 106 inputs the read acceleration sensor value to the acceleration sensor value holding unit 108 and the acceleration sensor value judging unit 110. The acceleration sensor value holding unit 108 stores the input acceleration sensor value as A0. Based on the input acceleration sensor value, the acceleration sensor value judging unit 110 determines whether the terminal device 100 is being held. The acceleration sensor value judging unit 110 inputs the judgment result into the non-held start time setting unit 114 and the non-held time period judging unit 116.

The terminal device 100 sets the start time of the time period during which the terminal device 100 is not being held (Step S304). For example, when the terminal device 100 being held is determined to be released and not held by hand anymore based on the judgment result input from the acceleration sensor value judging unit 110, the non-held start time setting unit 114 sets the time at which the judgment result is input. The non-held start time setting unit 114 stores the input time of the judgment result as a start time T0 of the time period during which the terminal device 100 is not being held.

The terminal device 100 determines whether a predetermined period of time has elapsed (Step S306). For example, based on the timer value input from the timer 104, the acceleration sensor reading unit 106 determines whether the predetermined period of time has elapsed since the previous reading time of the acceleration sensor value. The present embodiment is described through an example in which the predetermined period of time is 100 ms. The predetermined period of time can be changed accordingly.

If the predetermined period of time has not elapsed (Step S306: NO), the operation returns to Step S306. If the predetermined period of time has elapsed (Step S306: YES), the terminal device 100 reads the acceleration sensor value (Step S308). For example, the acceleration sensor reading unit 106 reads the sensor value input from the acceleration sensor 102. The acceleration sensor reading unit 106 inputs the read acceleration sensor value to the acceleration sensor value holding unit 108 and the acceleration sensor value judging unit 110. The acceleration sensor value holding unit 108 stores the input acceleration sensor value as A1.

Based on the input acceleration sensor value A1, the acceleration sensor value judging unit 110 determines whether the terminal device 100 is being held by the user. For example, the acceleration sensor value judging unit 110 determines whether the acceleration sensor value A1 is different from the acceleration sensor value A0 read in Step S302 (Step S310).

If the acceleration sensor value A1 and the acceleration sensor value A0 are the same (Step S310: NO), the operation returns to Step S306. If the acceleration sensor value A1 and the acceleration sensor value A0 are different from each other (Step S310: YES), the terminal device 100 determines whether the real time clock value has reached a predetermined period of time (Step S312). For example, the acceleration sensor value judging unit 110 inputs to the non-held time period judging unit 116 the judgment result of whether the acceleration sensor value A1 and the acceleration sensor value A0 are different. If the judgment result indicates that the acceleration sensor value A1 and the acceleration sensor value A0 are different, the non-held time period judging unit 116 determines whether the predetermined period of time has elapsed since the start time input from the non-held start time setting unit 114 based on the clock value input from the real time clock 112.

If the predetermined period of time has not elapsed since the start time (Step S312: NO), the operation returns to Step S302. In this case, the terminal device 100 determines that the terminal device 100 is temporarily placed at rest (i.e. in the static condition). If the predetermined period of time has elapsed since the start time (Step S312: YES), the terminal device 100 makes an audio output of the current time from the speaker (Step S314). For example, if the predetermined period of time has elapsed since the start time, the non-held time period judging unit 116 directs the audio output unit 118 to make an audio output. The direction may include information indicating the current time input from the real time clock 112. The audio output unit 118 makes an audio output of the current time in response to the direction input from the non-held time period judging unit 116.

When the terminal device 100 is kept in the static condition, the value of the acceleration sensor 102 is 1 G in the vertical direction. By detecting whether the value of the acceleration sensor 102 remains at 1 G in the vertical direction, it is possible to determine whether the terminal device 100 has been kept in the static condition for the predetermined period of time. Note however that the terminal device 100 is possibly placed in the static condition in various positions. Therefore, the acceleration sensor reading unit 106 may be designed to read values of multiple axes of the acceleration sensor 102, and determine the continuation of the static condition if the vector of the values is constant. In addition, in order to detect the static condition, the acceleration sensor reading unit 106 may determine whether the absolute value of the acceleration is 1 G. Note however that in the general use of the terminal device 100, it is not often the case that a value other than 1 G continues for a fixed period of time, and therefore, the static condition can be detected, not necessarily through the determination using the absolute value.

In the above described embodiment, in the case where the terminal device 100 does not include the real time clock 112, the terminal device 100 may be designed to perform the following process.

In Step S304 described above, a variable T indicating the time period for which the terminal device 100 is not being held is first set to zero. In this case, the variable T indicates a time period during which the terminal device 100 is assumed not to be held by the user, i.e. a time period during which the terminal device 100 is assumed to be placed on the floor, a desk or the like.

Also in Step S310 described above, if the acceleration sensor value A1 and the acceleration sensor value A0 are the same (Step S310: NO), a value obtained by adding a predetermined period of time to the variable T is set as a new variable T, and the operation returns to Step S306.

According to the present embodiment, since the detecting means for detecting a contact on the terminal device is provided, the user in bed is able to obtain desired information, e.g. the current time, by simply “touching the mobile telephone” which can be done relatively easily even in the dark.

Also according to the present embodiment, an acceleration sensor which has been installed in mobile telephones as a pedometer in increasing number can be used as the detecting means for detecting a contact on the terminal device. By using the acceleration sensor, the detecting means can be achieved without adding a new component to the terminal device. It is accordingly possible to prevent an increase in cost and size of the terminal device.

In addition, according to the present embodiment, an audio output is made in the case there is no detection of the terminal device being held for a fixed period of time, whereby it is possible to prevent making an audio output more often than necessary. For example, if the user is in his/her sleep, the terminal device is left in the static condition at least for a few hours. Therefore, the terminal device may be designed to determine to perform an audio output on the condition that the detecting means does not detect a contact on the terminal device for a predetermined period of time, for example, one hour.

In the case where the terminal device is not in the static condition, it is considered that the user is holding the terminal device and may be operating on the terminal device, and therefore, the user is probably able to obtain information from the terminal device. On the other hand, in the case where the terminal device has been in the static condition for a fixed period of time, it is likely that the user has not obtained information from the terminal device. Therefore, it is assumed that the user wants to obtain more information from the terminal device when the terminal device is held after being in the static condition for a fixed period of time. According to the present embodiment, the terminal device determines whether the terminal device has been in the static condition for a fixed period of time, and provides necessary information when the terminal device is held by the user after the passage of the fixed period of time. Herewith, it is possible to provide the user with information in an effective manner.

Also according to the present embodiment, information is output in audio format, whereby the user is able to obtain desired information without exposing his/her eyes accustomed to darkness to the bright display of the terminal device.

### (b) Second Embodiment

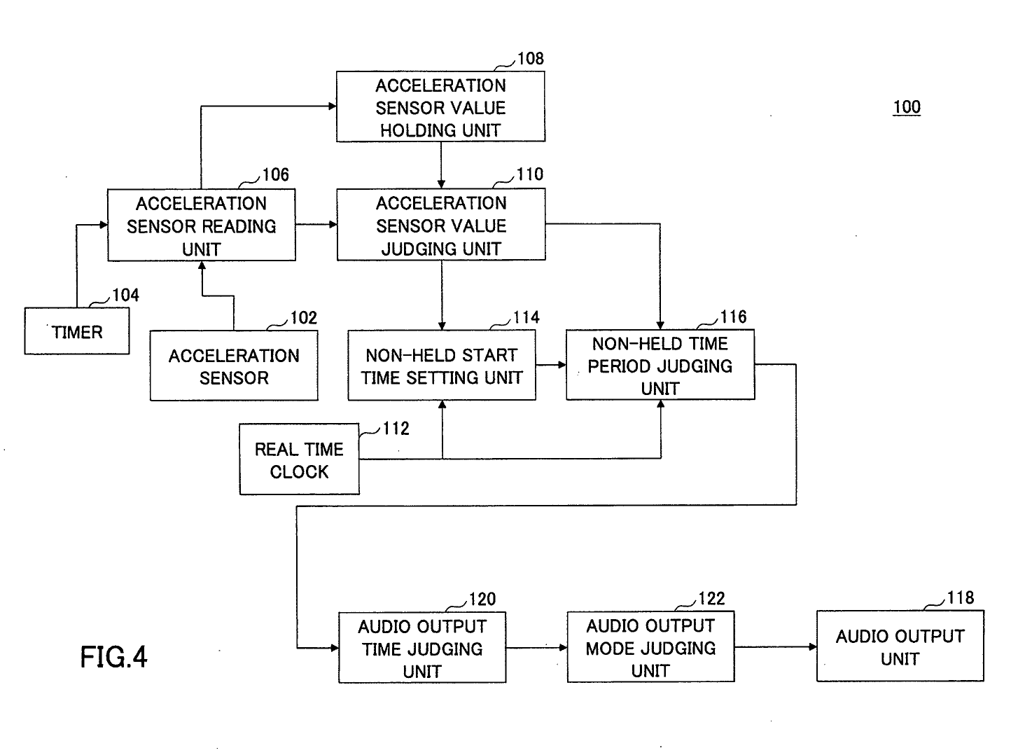

The terminal device 100 according to the second embodiment is explained next with reference to FIG. 4.

The present embodiment is characterized in that the terminal device 100 according to the embodiment described above makes an audio output in the case where the current time falls within a predetermined time frame during which audio outputs are allowed. Also, the present embodiment is characterized in that the terminal device 100 according to the embodiment described above makes the audio output in the case when the terminal device 100 is in an operation mode in which audio outputs are allowed.

The terminal device 100 of the present embodiment is structured such that an audio output time judging unit 120 is included in the terminal device 100 of FIG. 1. In response to the direction for performing an audio output input from the non-held time period judging unit 116, the audio output time judging unit 120 determines whether the current time included in the direction as information falls within a predetermined time frame. In the case where the current time included in the direction falls within the predetermined time frame, the audio output time judging unit 120 inputs the direction to an audio output mode judging unit 122 to be described below. Here, the predetermined time frame preferably represents a period of time during which a predetermined processing operation (in this case, the audio output process of the current time) is allowed to be executed.

The terminal device 100 of the present embodiment is structured such that the audio output mode judging unit 122 is included in the terminal device 100 of FIG. 1. The audio output mode judging unit 122 determines whether the terminal device 100 is in an operation mode in which an audio output is allowed to be executed. For example, the audio output mode judging unit 122 determines whether the terminal device 100 is in silent mode. This is because in silent mode, the terminal device 100 is caused to generate a vibration instead of sounding a ring tone, for example, when an incoming call arrives, and therefore is not able to make an audio output. In the case of determining that the terminal device 100 is in an operation mode in which an audio output can be made, the audio output mode judging unit 122 inputs the direction for performing an audio output to the audio output unit 118.

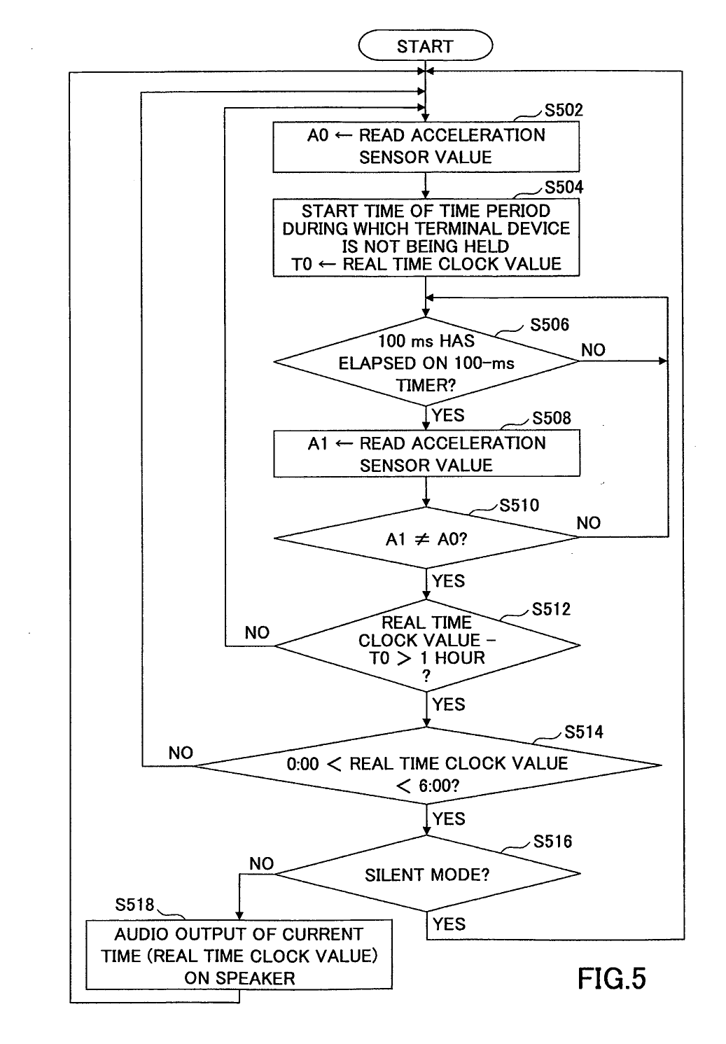

Operations of the terminal device 100 of the present embodiment are explained with reference to FIG. 5.

The present embodiment is described through an example in which a time window between 0:00 and 6:00 is the time frame during which an audio output is allowed.

The operations in Steps S502 through S512 of the terminal device 100 according to the present embodiment are the same as those in Steps S302 through S312 of FIG. 3.

In Step S512, the terminal device 100 determines whether the real time clock value has reached a predetermined period of time. For example, the acceleration sensor value judging unit 110 inputs to the non-held time period judging unit 116 the judgment result of whether the acceleration sensor value A1 and the acceleration sensor value A0 are different. If the judgment result indicates that the acceleration sensor value A1 and the acceleration sensor value A0 are different, the non-held time period judging unit 116 determines whether the predetermined period of time has elapsed since the start time input from the non-held start time setting unit 114 based on the clock value input from the real time clock 112. If the predetermined period of time has not elapsed since the start time (Step S512: NO), the operation returns to Step S502. If the predetermined period of time has elapsed since the start time (Step S512: YES), the terminal device 100 determines whether the current time falls within the time window between 0:00 and 6:00 (Step S514). For example, if the predetermined period of time has elapsed since the start time of the time period during which the terminal device 100 is not being held by the user, the non-held time period judging unit 116 directs the audio output unit 118 to make an audio output. The direction may include information indicating the current time input from the real time clock 112. Based on the information indicating the current time included in the direction, the audio output time judging unit 120 determines whether the current time falls within the time window between 0:00 and 6:00. The time window can be arbitrarily set.

If the current time falls outside the time window between 0:00 and 6:00 (Step S514: NO), the operation returns to Step S502. On the other hand, if the current time falls within the time window between 0:00 and 6:00 (Step S514: YES), the terminal device 100 determines whether the terminal device 100 is in silent mode (Step S516). In this case, for example, the audio output time judging unit 120 inputs to the audio output mode judging unit 122 the direction input from the non-held time period judging unit 116. Based on the input direction, the audio output mode judging unit 122 determines whether the terminal device 100 is in an operation mode in which an audio output is allowed to be executed. For example, the audio output mode judging unit 122 determines whether the terminal device 100 is in silent mode.

If the terminal device 100 is determined to be in an operation mode in which an audio output is not allowed (Step S516: YES), the operation returns to Step S502. On the other hand, if the terminal device 100 is determined to be not in an operation mode in which an audio output is not allowed (Step S516: NO), the terminal device 100 makes an audio output of the current time from the speaker. For example, the audio output mode judging unit 122 inputs to the audio output unit 118 the direction input from the audio output time judging unit 120. The direction may include information indicating the current time. In response to the direction input from the audio output mode judging unit 122, the audio output unit 118 makes an audio output of the current time.

According to the present embodiment, since the detecting means for detecting a contact on the terminal device is provided, the user in bed is able to obtain desired information, e.g. the current time, by simply “touching the mobile telephone” which can be done relatively easily even in the dark.

Also according to the present embodiment, an acceleration sensor which has been installed in mobile telephones as a pedometer in increasing numbers can be used as the detecting means for detecting a contact on the terminal device. By using the acceleration sensor, the detecting means can be achieved without adding a new component to the terminal device. It is accordingly possible to prevent an increase in cost and size of the terminal device.

In addition, according to the present embodiment, an audio output is made in the case there is no detection of the terminal device being held for a fixed period of time, whereby it is possible to prevent making an audio output more than necessary. For example, if the user is in his/her sleep, the terminal device is left in the static condition at least for a few hours. Therefore, the terminal device may be designed to perform an audio output on the condition that the detecting means does not detect a contact on the terminal device for a predetermined period of time, for example, one hour.

In the case where the terminal device is not in the static condition, it is considered that the user is holding the terminal device and may be operating on the terminal device, and therefore, the user is probably able to obtain information from the terminal device. On the other hand, in the case where the terminal device has been in the static condition for a fixed period of time, it is likely that the user has not obtained information from the terminal device. Therefore, it is assumed that the user wants to obtain more information from the terminal device when the terminal device is held after being in the static condition for a fixed period of time. According to the present embodiment, the terminal device determines whether the terminal device has been in the static condition for a fixed period of time, and provides necessary information when the terminal device is held by the user after the passage of the fixed period of time. Herewith, it is possible to provide the user with information in an effective manner.

Also according to the present embodiment, information is output in audio format, whereby the user is able to obtain desired information without exposing his/her eyes accustomed to darkness to the bright display of the terminal device.

Also the terminal device 100 of the present embodiment is configured to make an audio output only in the time window during which audio outputs are allowed to be executed. The time window may be set in advance.

Also the terminal device 100 of the present embodiment is configured to make an audio output only when in an operation mode in which audio outputs are allowed to be executed.

### (c) Third Embodiment

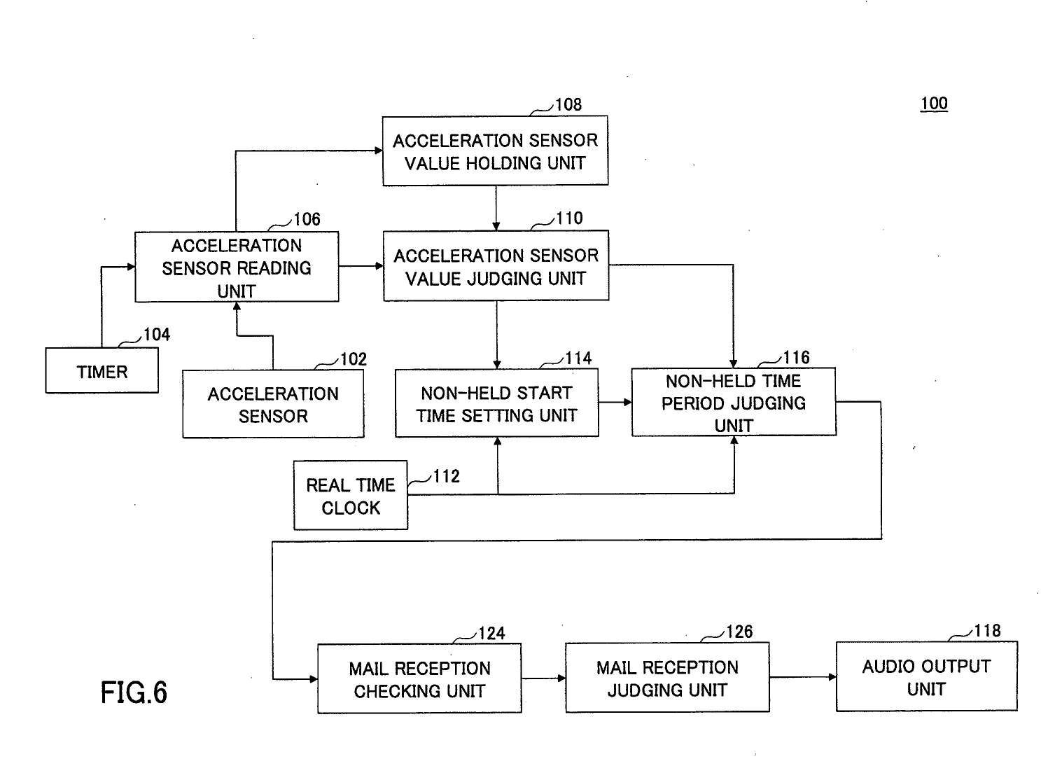

The terminal device 100 according to the third embodiment is explained next with reference to FIG. 6.

The terminal device 100 of the present embodiment determines whether mail has been received when detecting that the terminal device 100 is held by the user. If determining that mail has been received, the terminal device 100 makes an audio output regarding the mail reception.

In the terminal device 100 of the present embodiment, the non-held time period judging unit 116 obtains the elapsed time during which the terminal device 100 is not being held, based on the start time input from the non-held start time setting unit 114, the information input from the acceleration sensor value judging unit 110, and the clock value input from the real time clock 112. Then, if the obtained elapsed time is equal to or exceeds a predetermined period of time, the non-held time period judging unit 116 directs a mail reception checking unit 124 to be described below to report whether mail has been received.

The terminal device 100 of the present embodiment is structured such that the mail reception checking unit 124 is included in the terminal device 100 of FIG. 1. Based on the direction input from the non-held time period judging unit 116, the mail reception checking unit 124 checks whether mail has been received. The mail reception checking unit 124 inputs to a mail reception judging unit 126 information indicating whether the terminal device 100 has received mail. The information may include the direction input from the non-held time period judging unit 116.

The terminal device 100 of the present embodiment is structured such that the mail reception judging unit 126 is included in the terminal device 100 of FIG. 1. Based on the information input from the mail reception checking unit 124, the mail reception judging unit 126 determines whether the terminal device 100 has received mail. In the case where the terminal device 100 has received mail, the mail reception judging unit 126 inputs to the audio output unit 118 the direction input from the mail reception checking unit 124.

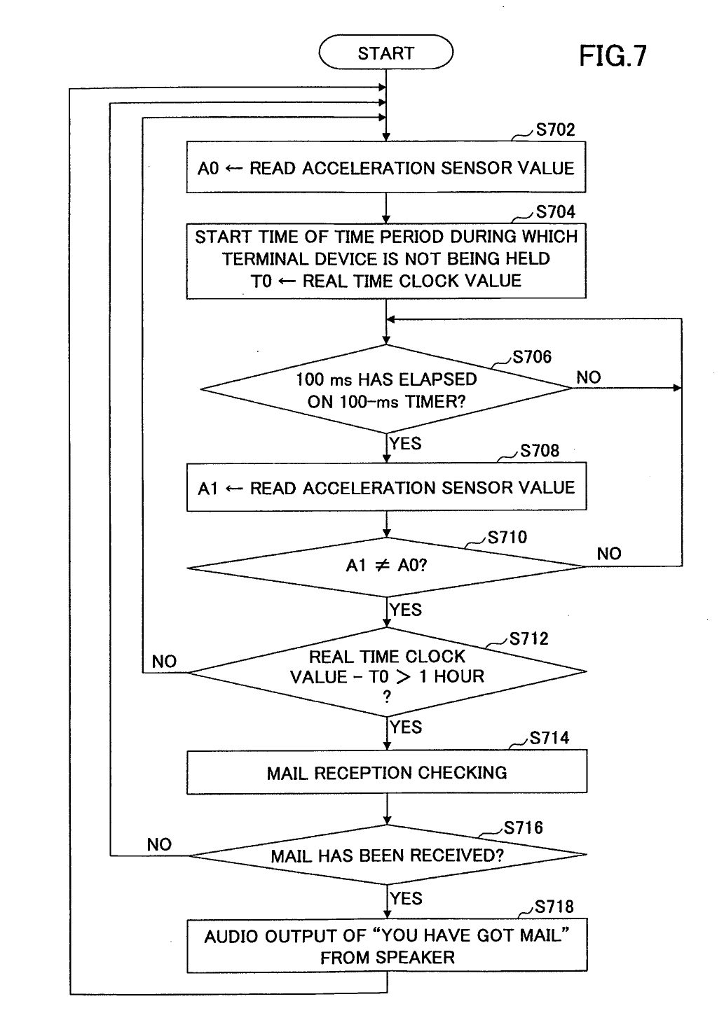

Operations of the terminal device 100 of the present embodiment are explained with reference to FIG. 7.

The operations in Steps S702 through S712 of the terminal device 100 according to the present embodiment are the same as those in Steps S302 through S312 of FIG. 3.

In Step S712, the terminal device 100 determines whether the real time clock value has reached a predetermined period of time. For example, the acceleration sensor value judging unit 110 inputs to the non-held time period judging unit 116 the judgment result of whether the acceleration sensor value A1 and the acceleration sensor value A0 are different. If the judgment result indicates that the acceleration sensor value A1 and the acceleration sensor value A0 are different, the non-held time period judging unit 116 determines whether the predetermined period of time has elapsed since the start time input from the non-held start time setting unit 114 based on the clock value input from the real time clock 112. If the predetermined period of time has not elapsed since the start time (Step S712: NO), the operation returns to Step S702. If the predetermined period of time has elapsed since the start time (Step S712: YES), the terminal device 100 determines whether mail has been received (Step S714). For example, in the case where the predetermined period of time has elapsed since the start time, the non-held time period judging unit 116 directs the mail reception checking unit 124 to inform whether mail has been received. Based on the direction input from the non-held time period judging unit 116, the mail reception checking unit 124 checks whether mail has been received. The mail reception checking unit 124 inputs the check result to the mail reception judging unit 126. The check result may include the direction input from the non-held time period judging unit 116.

The terminal device 100 determines whether mail has been received (Step S716). In the case where no mail has been received (Step S716: NO), the operation returns to step S702. On the other hand, if mail has been received (Step S716: YES), the terminal device 100 makes an audio output from the speaker, indicating that there is received mail. For example, based on the check result input from the mail reception checking unit 124, the mail reception judging unit 126 determines whether the terminal device 100 has received mail. When determining that mail has been received, the mail reception judging unit 126 inputs to the audio output unit 118 the direction input from the mail reception checking unit 124. The direction may include a direction for informing whether mail has been received. In response to the direction input from the mail reception judging unit 126, the audio output unit 118 makes an audio output indicating that there is received mail.

According to the present embodiment, since the detecting means for detecting a contact on the terminal device is provided, the user in bed is able to obtain desired information, e.g. the current time, by simply “touching the mobile telephone” which can be done relatively easily even in the dark.

Also according to the present embodiment, an acceleration sensor which has been installed in mobile telephones as a pedometer in increasing numbers can be used as the detecting means for detecting a contact on the terminal device. By using the acceleration sensor, the detecting means can be achieved without adding a new component to the terminal device. It is accordingly possible to prevent an increase in cost and size of the terminal device.

In addition, according to the present embodiment, an audio output is made in the case there is no detection of the terminal device being held for a fixed period of time, whereby it is possible to prevent making an audio output more often than necessary. For example, if the user is in his/her sleep, the terminal device is left in the static condition at least for a few hours. Therefore, the terminal device may be designed to perform an audio output on the condition that the detecting means does not detect a contact on the terminal device for a predetermined period of time, for example, one hour.

In the case where the terminal device is not in the static condition, it is considered that the user is holding the terminal device and may be operating on the terminal device, and therefore, the user is probably able to obtain information from the terminal device. On the other hand, in the case where the terminal device has been in the static condition for a fixed period of time, it is likely that the user has not obtained information from the terminal device. Therefore, it is assumed that the user wants to obtain more information from the terminal device when the terminal device is held after being in the static condition for a fixed period of time. According to the present embodiment, the terminal device determines whether the terminal device has been in the static condition for a fixed period of time, and provides necessary information when the terminal device is held by the user after the passage of the fixed period of time. Herewith, it is possible to provide the user with information in an effective manner.

Also according to the present embodiment, information is output in audio format, whereby the user is able to obtain desired information without exposing his/her eyes accustomed to darkness to the bright display of the terminal device.

### (d) Fourth Embodiment

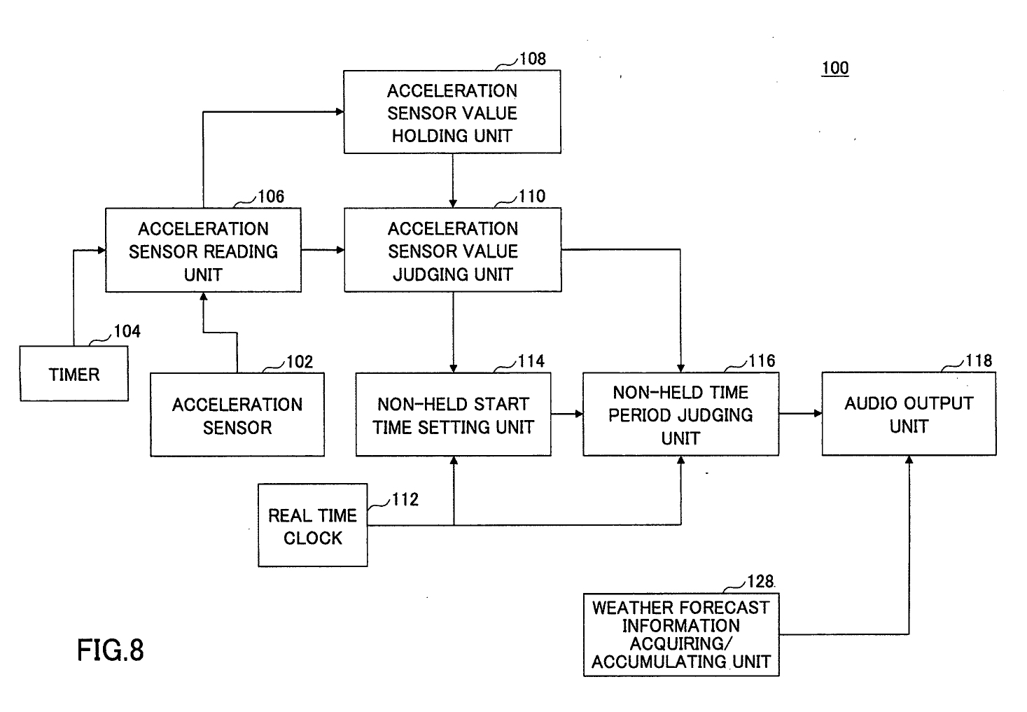

The terminal device 100 according to the fourth embodiment is explained next with reference to FIG. 8.

The terminal device 100 of the present embodiment outputs a weather forecast in audio format when a predetermined period of time has elapsed after the terminal device 100 is released from the grasp of the user's hand (i.e. placed at rest).

In the terminal device 100 of the present embodiment, the non-held time period judging unit 116 obtains the elapsed time during which the terminal device 100 is not being held, based on the start time input from the non-held start time setting unit 114, the information input from the acceleration sensor value judging unit 110, and the clock value input form the real time clock 112. Then, if the obtained elapsed time is equal to or exceeds a predetermined period of time, the non-held time period judging unit 116 directs the audio output unit 118 to make an audio output of a weather forecast.

The terminal device 100 of the present embodiment is structured such that a weather forecast information acquiring/accumulating unit 128 is included in the terminal device 100 of FIG. 1. The weather forecast information acquiring/accumulating unit 128 obtains and accumulates weather forecast information. For example, the weather forecast information acquiring/accumulating unit 128 may obtain weather forecast information at regular time intervals. The regular time interval preferably spans a time duration that allows the weather forecast information to be updated. The weather forecast information acquiring/accumulating unit 128 may acquire the weather forecast information via a network or data broadcasting. The weather forecast information acquiring/accumulating unit 128 inputs the accumulated weather forecast information to the audio output unit 118. It is desirable that the weather forecast information acquiring/accumulating unit 128 input to the audio output unit 118 the latest weather forecast information included in the accumulated weather forecast information.

In response to a direction input from the non-held time period judging unit 116, the audio output unit 118 makes an audio output of weather forecast input from the weather forecast information acquiring/accumulating unit 128.

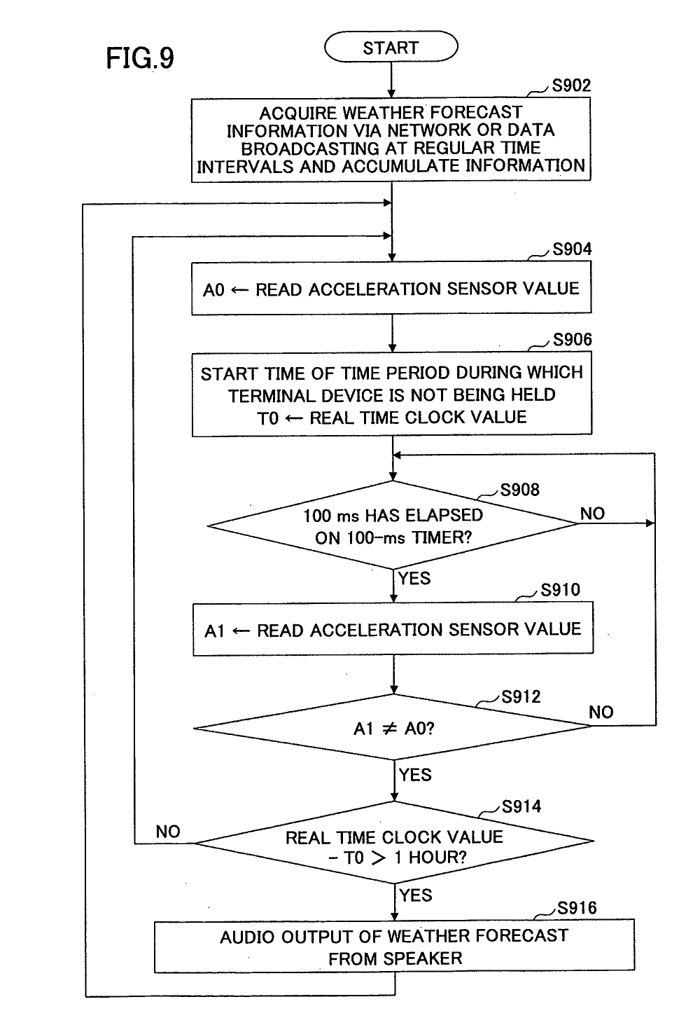

Operations of the terminal device 100 of the present embodiment are explained with reference to FIG. 9.

The terminal device 100 acquires and accumulates weather forecast information via a network or data broadcasting at regular time intervals (Step S902). This step may be performed by, for example, the weather forecast information acquiring/accumulation unit 128.

The operations in Steps S904 through S914 of the terminal device 100 according to the present embodiment are the same as those in Steps S302 through S312 of FIG. 3.

In Step S914, the terminal device 100 determines whether the real time clock value has reached a predetermined period of time. For example, the acceleration sensor value judging unit 110 inputs to the non-held time period judging unit 116 the judgment result of whether the acceleration sensor value A1 and the acceleration sensor value A0 are different. If the judgment result indicates that the acceleration sensor value A1 and the acceleration sensor value A0 are different, the non-held time period judging unit 116 determines whether the predetermined period of time has elapsed since the start time input from the non-held start time setting unit 114 based on the clock value input from the real time clock 112. If the predetermined period of time has not elapsed since the start time (Step S914: NO), the operation returns to Step S904. If the predetermined period of time has elapsed since the start time (Step S914: YES), the terminal device 100 makes an audio output of a weather forecast from the speaker (Step S916). For example, if the predetermined period of time has elapsed since the start time of the time period during which the terminal device 100 is not being held by the user, the non-held time period judging unit 116 directs the audio output unit 118 to make a weather forecast audio output. In response to the direction input from the non-held time period judging unit 116, the audio output unit 118 makes an audio output of the weather forecast information input from the weather forecast information acquiring/accumulating unit 128. Subsequently, the operation returns to Step S904.

According to the present embodiment, since the detecting means for detecting a contact on the terminal device is provided, the user in bed is able to obtain desired information, e.g. the current time, by simply “touching the mobile telephone” which can be done relatively easily even in the dark.

Also according to the present embodiment, an acceleration sensor which has been installed in mobile telephones as a pedometer in increasing numbers can be used as the detecting means for detecting a contact on the terminal device. By using the acceleration sensor, the detecting means can be achieved without adding a new component to the terminal device. It is accordingly possible to prevent an increase in cost and size of the terminal device.

In addition, according to the present embodiment, an audio output is made in the case there is no detection of the terminal device being held for a fixed period of time, whereby it is possible to prevent making an audio output more often than necessary. For example, if the user is in his/her sleep, the terminal device is left in the static condition at least for a few hours. Therefore, the terminal device may be designed to perform an audio output on the condition that the detecting means does not detect a contact on the terminal device for a predetermined period of time, for example, one hour.

In the case where the terminal device is not in the static condition, it is considered that the user is holding the terminal device and may be operating on the terminal device, and therefore, the user is probably able to obtain information from the terminal device. On the other hand, in the case where the terminal device has been in the static condition for a fixed period of time, it is likely that the user has not obtained information from the terminal device. Therefore, it is assumed that the user wants to obtain more information from the terminal device when the terminal device is held after being in the static condition for a fixed period of time. According to the present embodiment, the terminal device determines whether the terminal device has been in the static condition for a fixed period of time, and provides necessary information when the terminal device is held by the user after the passage of the fixed period of time. Herewith, it is possible to provide the user with information in an effective manner.

Also according to the present embodiment, information is output in audio format, whereby the user is able to obtain desired information without exposing his/her eyes accustomed to darkness to the bright display of the terminal device.

### (e) Fifth Embodiment

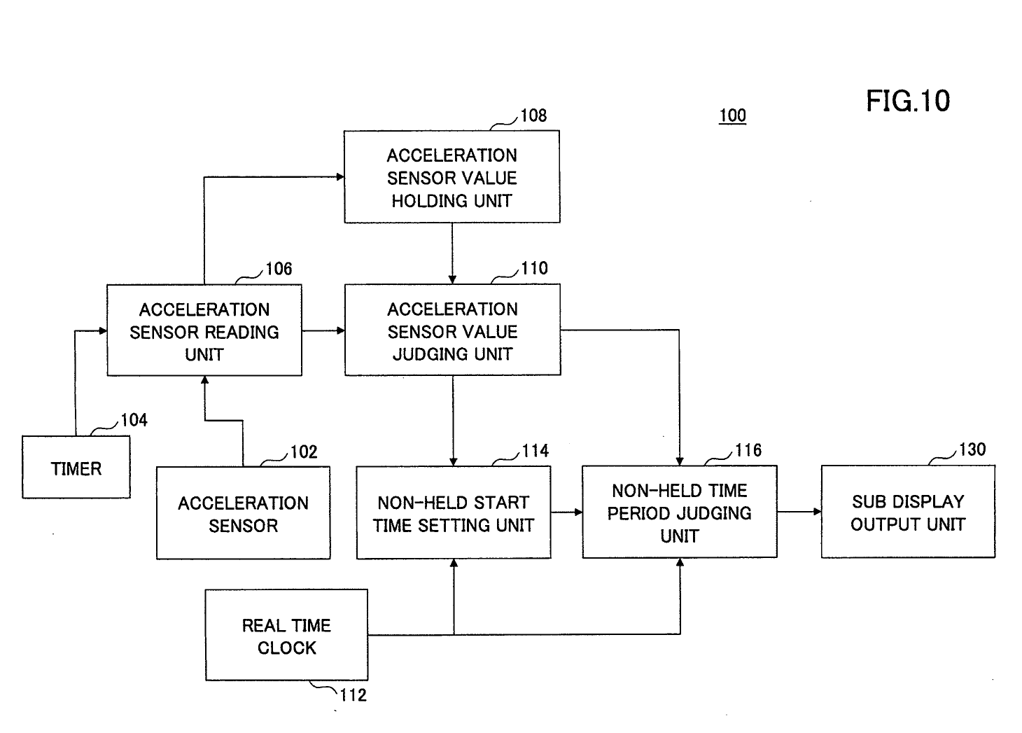

The terminal device 100 according to the fifth embodiment is explained next with reference to FIG. 10.

The terminal device 100 of the present embodiment displays the current time on a sub display when a predetermined period of time has elapsed after the terminal device 100 is released from the grasp of the user's hand (i.e. placed at rest).

In the terminal device 100 of the present embodiment, the non-held time period judging unit 116 obtains the elapsed time during which the terminal device 100 is not being held, based on the start time input from the non-held start time setting unit 114, the information input from the acceleration sensor value judging unit 110, and the clock value input from the real time clock 112. Then, if the obtained elapsed time is equal to or exceeds a predetermined period of time, the non-held time period judging unit 116 directs a sub display output unit 130 to display the current time.

The terminal device 100 of the present embodiment includes the sub display output unit 130 instead of the audio output unit 118 of the terminal device 100 of FIG. 1. The sub display output unit 130 outputs the current time on the sub display. The previous embodiments describe cases of making outputs in audio format; however, audio outputs may bother people near the terminal device 100. Therefore, by presenting the current time on the sub display, such a disturbance can be prevented. Also, compared to the main display, the display on the sub display does not cast too much light onto the eye. This is because the sub display is smaller in size than the main display and has a low illumination intensity so as to be suitable for checking the time in bed, for example.

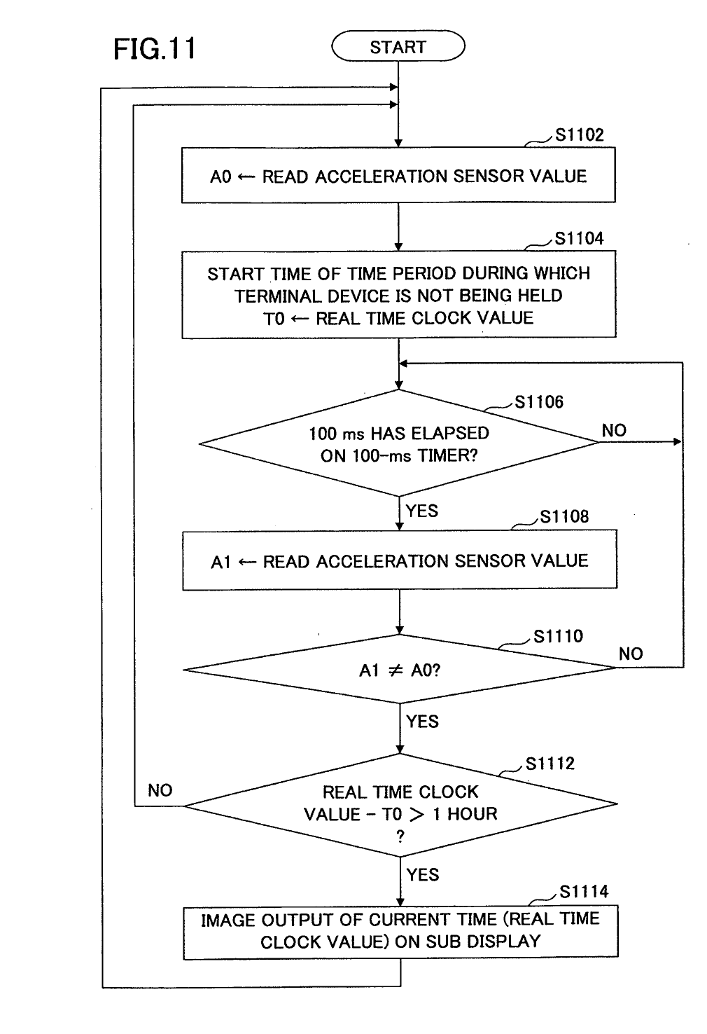

Operations of the terminal device 100 of the present embodiment are explained with reference to FIG. 11.

The operations in Steps S1102 through S1112 of the terminal device 100 according to the present embodiment are the same as those in Steps S302 through S312 of FIG. 3.

In Step S1112, the terminal device 100 determines whether the real time clock value has reached a predetermined period of time. For example, the acceleration sensor value judging unit 110 inputs to the non-held time period judging unit 116 the judgment result of whether the acceleration sensor value A1 and the acceleration sensor value A0 are different. If the judgment result indicates that the acceleration sensor value A1 and the acceleration sensor value A0 are different, the non-held time period judging unit 116 determines whether the predetermined period of time has elapsed since the start time input from the non-held start time setting unit 114 based on the clock value input from the real time clock 112. If the predetermined period of time has not elapsed since the start time (Step S1112: NO), the operation returns to Step S1102. If the predetermined period of time has elapsed since the start time (Step S1112: YES), the terminal device 100 makes an image output of the current time to the sub display (Step S1114). For example, if the predetermined period of time has elapsed since the start time of the time period during which the terminal device 100 is not being held by the user, the non-held time period judging unit 116 directs the sub display output unit 130 to output the current time. In response to the direction input from the non-held time period judging unit 116, the sub display output unit 130 displays the current time on the sub display. Subsequently, the operation returns to Step S1102.

According to the present embodiment, since the detecting means for detecting a contact on the terminal device is provided, the user in bed is able to obtain desired information, e.g. the current time, by simply “touching the mobile telephone” which can be done relatively easily even in the dark.

Also according to the present embodiment, an acceleration sensor which has been installed in mobile telephones as a pedometer in increasing numbers can be used as the detecting means for detecting a contact on the terminal device. By using the acceleration sensor, the detecting means can be achieved without adding a new component to the terminal device. It is accordingly possible to prevent an increase in cost and size of the terminal device.

In addition, according to the present embodiment, an audio output is made in the case there is no detection of the terminal device being held for a fixed period of time, whereby it is possible to prevent making an audio output more often than necessary. For example, if the user is in his/her sleep, the terminal device is left in the static condition at least for a few hours. Therefore, the terminal device may be designed to perform an audio output on the condition that the detecting means does not detect a contact on the terminal device for a predetermined period of time, for example, one hour.

In the case where the terminal device is not in the static condition, it is considered that the user is holding the terminal device and may be operating on the terminal device, and therefore, the user is probably able to obtain information from the terminal device. On the other hand, in the case where the terminal device has been in the static condition for a fixed period of time, it is likely that the user has not obtained information from the terminal device. Therefore, it is assumed that the user wants to obtain more information from the terminal device when the terminal device is held after being in the static condition for a fixed period of time. According to the present embodiment, the terminal device determines whether the terminal device has been in the static condition for a fixed period of time, and provides necessary information when the terminal device is held by the user after the passage of the fixed period of time. Herewith, it is possible to provide the user with information in an effective manner.

Also, according to the present embodiment, the information is output as an image, and therefore, the terminal device does not bother people nearby with audio outputs. Furthermore, compared to the main display, the display on the sub display does not cast too much light onto the eye.

### (f) Sixth Embodiment

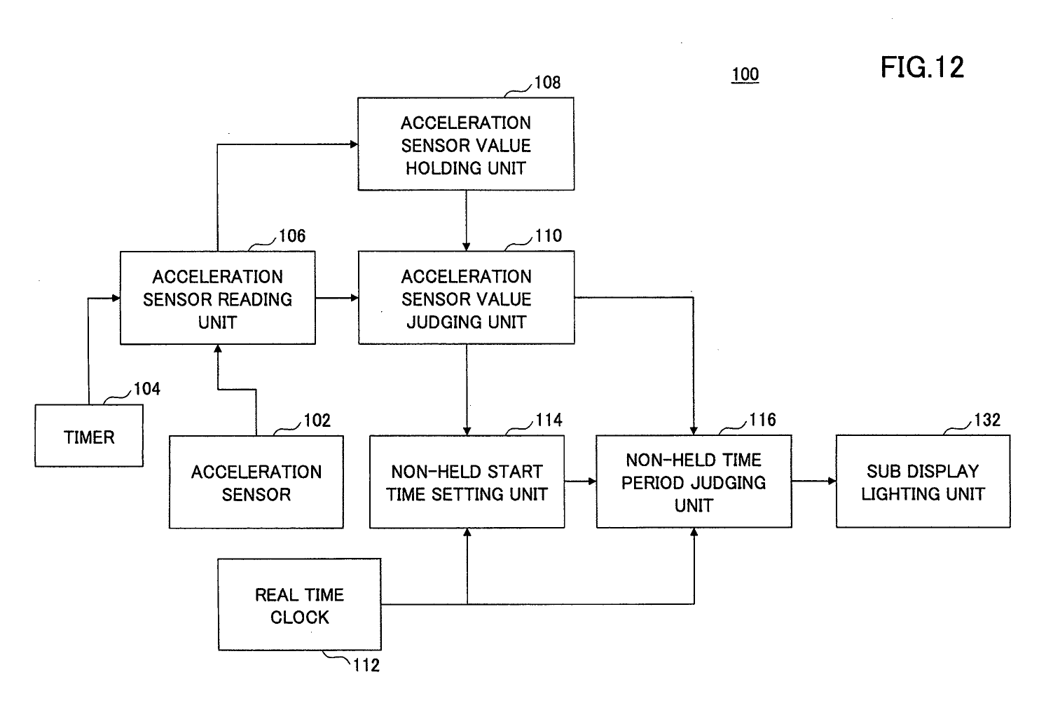

The terminal device 100 according to the sixth embodiment is explained next with reference to FIG. 12.

Some terminal devices display the current time on the sub display, and the backlight of the sub display is in OFF mode in order to save electric power. The present embodiment is directed to such a terminal device in which the current time is displayed on the sub display and the backlight of the sub display is in OFF mode for electric power savings, and the terminal device 100 of the present embodiment causes the backlight of the sub display to turn on. Herewith, it is possible to make the current time displayed on the sub display more visible.

In the terminal device 100 of the present embodiment, the non-held time period judging unit 116 obtains the elapsed time during which the terminal device 100 is not being held, based on the start time input from the non-held start time setting unit 114, the information input from the acceleration sensor value judging unit 110, and the clock value input form the real time clock 112. Then, if the obtained elapsed time is equal to or exceeds a predetermined period of time, the non-held time period judging unit 116 directs a sub display lighting unit 132 to be described below to turn on the backlight of the sub display.

The terminal device 100 of the present embodiment includes the sub display lighting unit 132 instead of the audio output unit 118 of the terminal device 100 of FIG. 1. The sub display lighting unit 132 turns on the backlight of the sub display.

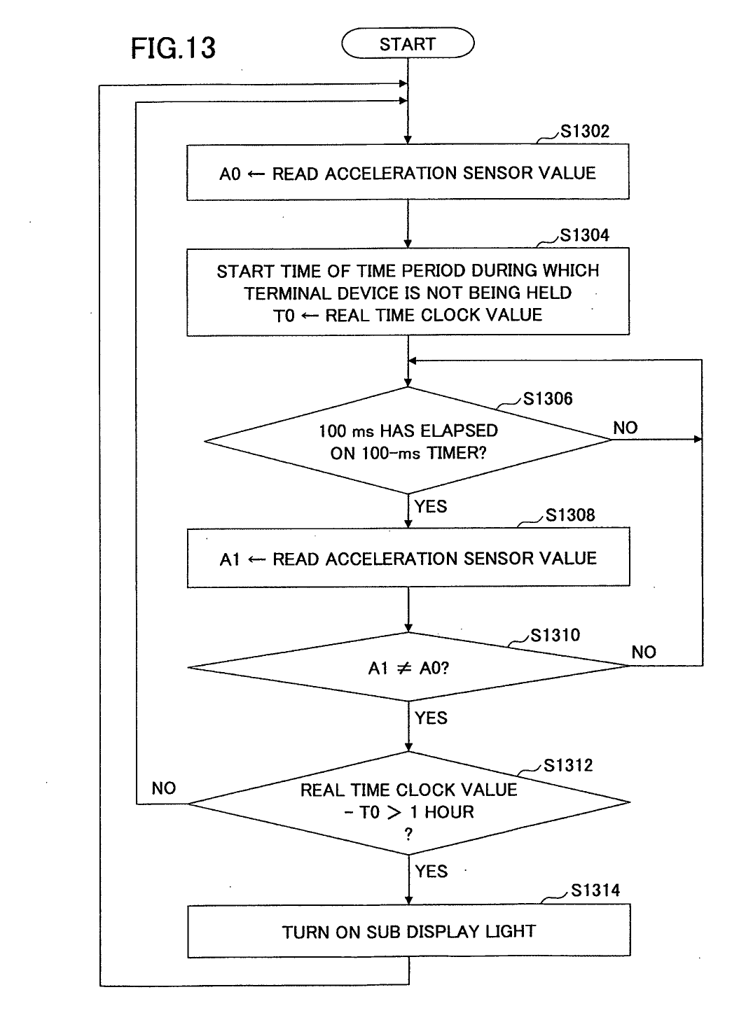

Operations of the terminal device 100 of the present embodiment are explained with reference to FIG. 13.

The operations in Steps S1302 through S1312 of the terminal device 100 according to the present embodiment are the same as those in Steps S302 through S312 of FIG. 3.

In Step S1312, the terminal device 100 determines whether the real time clock value has reached a predetermined period of time. For example, the acceleration sensor value judging unit 110 inputs to the non-held time period judging unit 116 the judgment result of whether the acceleration sensor value A1 and the acceleration sensor value A0 are different. If the judgment result indicates that the acceleration sensor value A1 and the acceleration sensor value A0 are different, the non-held time period judging unit 116 determines whether the predetermined period of time has elapsed since the start time input from the non-held start time setting unit 114 based on the clock value input from the real time clock 112. If the predetermined period of time has not elapsed since the start time (Step S1312: NO), the operation returns to Step S1302. If the predetermined period of time has elapsed since the start time (Step S1312: YES), the terminal device 100 makes an image output of the current time on the sub display (Step S1314). For example, if the predetermined period of time has elapsed since the start time of the time period during which the terminal device 100 is not being held by the user, the non-held time period judging unit 116 directs the sub display lighting unit 132 to turn on the backlight of the sub display. In response to the direction input from the non-held time period judging unit 116, the sub display lighting unit 132 turns on the backlight of the sub display. Subsequently, the operation returns to Step S1302.

According to the present embodiment, since the detecting means for detecting a contact on the terminal device is provided, the user in bed is able to obtain desired information, e.g. the current time, by simply “touching the mobile telephone” which can be done relatively easily even in the dark.

Also according to the present embodiment, an acceleration sensor which has been installed in mobile telephones as a pedometer in increasing numbers can be used as the detecting means for detecting a contact on the terminal device. By using the acceleration sensor, the detecting means can be achieved without adding a new component to the terminal device. It is accordingly possible to prevent an increase in cost and size of the terminal device.

In addition, according to the present embodiment, the backlight of the sub display is turned on in the case there is no detection of the terminal device being held for a fixed period of time, whereby it is possible to prevent turning on the backlight more than necessary. For example, if the user is in his/her sleep, the terminal device is left in the static condition at least for a few hours. Therefore, the terminal device may be designed to perform an audio output on the condition that the detecting means does not detect a contact on the terminal device for a predetermined period of time, for example, one hour.

In the case where the terminal device is not in the static condition, it is considered that the user is holding the terminal device and may be operating on the terminal device, and therefore, the user is probably able to obtain information from the terminal device. On the other hand, in the case where the terminal device has been in the static condition for a fixed period of time, it is likely that the user has not obtained information from the terminal device. Therefore, it is assumed that the user wants to obtain more information from the terminal device when the terminal device is held after being in the static condition for a fixed period of time. According to the present embodiment, the terminal device determines whether the terminal device has been in the static condition for a fixed period of time, and provides necessary information when the terminal device is held by the user after the passage of the fixed period of time. Herewith, it is possible to provide the user with information in an effective manner.

The present embodiment turns on the backlight of the sub display of the terminal device 100 which is designed such that the current time is displayed on the sub display and the backlight of the sub display is in OFF mode for electric power savings. Herewith, it is possible to make the current time displayed on the sub display more visible.

In conclusion, according to the terminal device and the method of the present disclosure, a specific output process can be executed when the terminal device is detected to be held by the user.

For convenience of explanation, the present disclosure is described in separate embodiments; however, such separation of the embodiments is not essential to the present disclosure, and two or more embodiments may be combined if desired. To facilitate understanding of the present disclosure, the embodiments are described using specific numeric values; however, those numeric values are merely examples unless otherwise noted, and any values may be used.

While several embodiments of the present disclosure have been described above, it should be apparent that each embodiment is merely an example and various modifications, adjustments, alterations, replacements and the like may occur to persons skilled in the art. For convenience of explanation, the device of each embodiment of the present disclosure is explained with the use of a functional block diagram; however, the device may be achieved by hardware, software, or a combination of them. It should, therefore, be noted that the present disclosure is not limited to the above-described embodiments and covers all such modifications, adjustments, alterations and replacements without departing from the scope and spirit of the present disclosure.

All examples and conditional language used herein are intended for pedagogical purposes to aid the reader in understanding the present disclosure and the concepts contributed by the inventor to furthering the art, and are to be construed as being without limitation to such specifically recited examples and conditions, nor does the organization of such examples in the specification relate to a showing of the superiority or inferiority of the present disclosure. Although the embodiments of the present disclosure have been described in detail, it should be understood that various changes, substitutions, and alterations could be made hereto without departing from the spirit and scope of the present disclosure.

What is claimed is:

1. A terminal device comprising:
a detecting unit configured to detect whether the terminal device is held by a user;
a judging unit configured to determine whether a predetermined condition is satisfied in a case where the terminal device is detected to be held; and
an output unit configured to make a predetermined output in a case where the predetermined condition is determined to be satisfied.

2. The terminal device as claimed in claim 1, wherein the detecting unit includes at least one of an acceleration sensor, an angular velocity sensor, a force sensor and an electrostatic sensor.

3. The terminal device as claimed in claim 2, wherein the detecting unit periodically obtains a parameter related to whether the terminal device is held by the user and determines that the terminal device is held in a case where a previously detected value of the parameter is different from a currently detected value of the parameter.

4. The terminal device as claimed in claim 1, wherein the judging unit determines that the predetermined condition is satisfied in a case where a predetermined time period has elapsed after the terminal device previously being held and then released.

5. The terminal device as claimed in claim 4, wherein the judging unit determines that the predetermined condition is satisfied in a case where a current time falls within a predetermined time frame.

6. The terminal device as claimed in claim 5, wherein the judging unit determines that the predetermined condition is satisfied in a case where the terminal device is in an operation mode in which an audio output is allowed to be executed.

7. The terminal device as claimed in claim 1, wherein the predetermined output of the output unit is made in an audio format or a display format.

8. The terminal device as claimed in claim 7, wherein the predetermined output relates to at least one of a current time, a weather forecast and whether mail has been received.

9. A method used on a terminal device, comprising:
detecting whether the terminal device is held by a user;
determining whether a predetermined condition is satisfied in a case where the terminal device is detected to be held; and
making a predetermined output in a case where the predetermined condition is determined to be satisfied.
